(19) United States
(12) Patent Application Publication
(10) Pub. No.: US 2018/0047241 A1
(43) Pub. Date: Feb. 15, 2018

(54) COIN DELIVERY SYSTEM WITH TEMPORARY HOLDING STACK DEVICE

(71) Applicant: Xerox Corporation, Norwalk, CT (US)

(72) Inventors: David R. Ascroft, Herts (GB); Simon J. Gray, Bedfordshire (GB); John K. Mangan, Hertfordshire (GB); Peter D. Fraser, Herts (GB)

(73) Assignee: Xerox Corporation, Norwalk, CT (US)

(21) Appl. No.: 15/234,495

(22) Filed: Aug. 11, 2016

(51) Int. Cl. G07F 1/04

(52) U.S. Cl. CPC G07F 1/047

(57) ABSTRACT

A coin delivery system adapted for use in coin-operated vending machines. The coin delivery system utilizes a temporary holding stack device designed to temporarily hold one or more coins during a transaction, thereby decoupling the coin sorting from the user transaction, whereby the pace of the sorting is avoided for completing verification of the user transaction.

### TECHNICAL FIELD

The presently disclosed embodiments are directed to coin delivery systems, more particularly to a coin delivery system suitable for use in a coin-operated vending machine, and still more particularly to a coin delivery system having a temporary holding stack device wherein the coins are validated prior to delivery and storage in a particular coin denomination drum, said coin delivering system suitable for use in a coin-operated vending machine.

### BACKGROUND

Vending machines, such as, for example, food vending machines, beverage vending machines, ticket vending machines, etc. are provided in many public areas. Such vending machines are designed to dispense one or more goods and/or services upon receipt of a minimum predetermined or required input. The types of vending machines can range from a simple mechanical design to a more complicated electrical and/or electro-mechanical design. Generally, these machines are coin-operated, and include a coin delivery system wherein once a pre-determined minimum payment has been received by the vending machine, the machine operates to dispense the purchased goods and/or services.

One type of vending machine, a parking ticket vending machine is typically provided in public parking lots. When it is desired by a user (i.e. a driver) to park in a parking space in a parking lot having such a parking ticket vending machine, the user must deposit coins totaling the required minimum fee in the coin input slot(s) of the vending machine. Once the required fee has been paid, the parking ticket vending machine operates to dispense the ticket. Typically, after the parking ticket is dispensed, the user places the parking ticket on the dashboard of the vehicle to verify the payment of the required parking fee.

However, existing types of vending machines suffer from many drawbacks and/or disadvantages in that the transaction process (i.e. the process from payment to dispensing of the goods and/or services) is often too time-consuming and is susceptible to many mechanical failures to the irritation and disappointment of the system users.

In many cases, the time-consuming nature of these existing vending machines is due to inadequate coin delivery systems. In addition, the coins must be inserted and sorted one-by-one by the coin delivery system prior to the completion of the transaction, thereby increasing the end-to-end duration of the transaction.

Current methods for delivering a coin in vending machines having such a coin delivery system involve a coin transport unit which houses a coin carriage. Typically, the coin carriage receives a coin from a coin verifier and is caused to move along the coin transport unit by a stepper motor unit until the coin carriage reaches its final destination above a coin drum.

In addition to the reliance on many moving parts before the transaction is completed (i.e. before the ticket is printed) and the time-consuming mechanism of such moving parts, the stepper motor driving the moving parts can also increase the end-to-end duration of the transaction. For example, the speed of the motor is typically limited by: 1) the amount of torque which can be applied by the motor, and/or 2) the ability to stop the motor accurately at the correct position above the coin drum. Furthermore, ramping up the motor too quickly typically results in frequent motor stalls.

As such, the time taken to drive the coin carriage to its destination above the coin drum and back to its home position to receive another coin is extensive, typically ranging from about 1-2 seconds. During the process of moving the coin carriage to the destination, releasing the coin at its destination and returning to its home position, the entry of another coin into the coin delivery system is inhibited. In transactions involving a plurality of coins, the transaction time may become unreasonable, thereby providing an unfavorable end-to-end user experience.

There is thus a need for an improved coin delivery system which can separate the sorting of coins into specific coin drums from the user transaction or at least the verification of the deposited value of coinage, thereby providing a more efficient coin delivery system and an enhanced end-to-end user experience.

There is also a need for a temporary holding stack device suitable for use in existing and future types of coin-operated vending machines and capable of temporarily holding one or more coins during the transaction prior to being sorted and routed to the coin holding drum.

### BRIEF DESCRIPTION

According to aspects illustrated herein, there is provided a coin delivery system adapted for use in a vending machine such that coins inputted into the vending machine are held in a temporary holding stack. The temporary holding stack is positioned after the coin verifier, i.e. downstream thereof, but before the coin transport mechanism, which said coin transport mechanism sits above the coin holding drums. From the temporary holding stack, the coins can be all returned to the customer if the transaction is aborted, or moved to the holding drums after all the coins have been received. As such, the transport to the drums does not limit the pace of the transaction for the customer, yet all customer requirements are met for verification of amount deposited, and return of all coins for a cancelled transaction.

According to aspects illustrated herein, there is provided a system for delivering coins during a vending machine transaction, said coins inserted by way of payment, and said vending machine designed to dispense a good or service, the coin delivery system comprising: a coin identification device capable of identifying and verifying an inserted coin type; a coin temporary holding device disposed downstream of the coin identification device and capable of temporarily holding an identified coin received from the coin identification device; and, a coin sorting device disposed downstream of the coin temporary holding device and capable of sorting the identified coin held by the coin temporary holding device, whereby a pace of sorting an identified coin has no effect on the identifying and verifying of inserted coins.

According to aspects illustrated herein, there is provided a system for delivering coins during a vending machine transaction, said coins inserted by way of payment, and said vending machine designed to dispense a good or service, the coin delivery system comprising: a coin inlet having a coin input slot into which coins are inserted, said coin inlet also having a coin output slot; a coin verifier having a coin input slot connected to the coin output slot of the coin input and adapted to verify the inserted coins, said coin verifier having a coin output slot; a temporary holding stack device having a coin input slot connected to the coin output slot of the coin verifier and an internal cavity adapted to temporarily hold the inserted coins during the transaction, said temporary holding stack having a coin output slot; a coin transport having a coin input slot connected to the coin output slot of the temporary holding stack and adapted to facilitate the transport of coins from the temporary holding stack, said coin transport having at least one coin output slot; and, a coin drum having at least one coin input slot connected to the at least one coin output slot of the coin transport and adapted to receive and store coins from the coin transport, wherein said temporary holding stack device further comprises one or more coin holding units spaced apart and positionable within the internal cavity of the temporary holding stack device and adapted to hold the coins inserted during the transaction after verification by the coin verifier and prior to reception in the coin drum.

According to aspects illustrated herein, there is provided a temporary holding stack device adapted for use in a coin-operated vending machine, the device comprising: a coin input slot capable of facilitating the insertion of coins inserted by way of payment during a vending machine transaction into the temporary holding stack device; an internal cavity adapted to temporarily hold the inserted coins during the transaction; a plurality of coin holding units positionable within said internal cavity of the temporary holding stack device and adapted to hold the coins inserted during the transaction; and, a coin output slot capable of facilitating the removal of the coins temporarily held by the temporary holding stack device, wherein the coin holding units are spaced apart such that the held coins are not in contact with other coins inserted during the same transaction.

According to aspects illustrated herein, there is provided a system for delivering coins during a vending machine transaction, said coins inserted by way of payment, and said vending machine designed to dispense a good or service, the coin delivery system comprising a temporary holding stack device, wherein the coin delivery system is capable of performing the user transaction separate from the sorting of inserted coins.

### BRIEF DESCRIPTION OF THE DRAWINGS

FIG. 1 is a perspective illustration of a vending machine system in accordance with one embodiment of the present disclosure;

FIG. 2 is a perspective illustration of a coin delivery system in accordance with one embodiment of the present disclosure;

FIG. 3 is a sequence diagram illustration of a coin delivery system in accordance with one embodiment of the present disclosure;

FIG. 4 is a perspective illustration of a temporary holding stack device in accordance with one embodiment of the present disclosure;

FIG. 5 is a perspective illustration of a temporary holding stack device in accordance with another embodiment of the present disclosure;

FIG. 6 is an exploded-view, perspective illustration of an existing coin transporter assembly;

FIG. 7 is a functional block diagram illustrating an existing coin delivery system; and,

FIG. 8 is a sequence diagram of an existing coin delivery system.

### DETAILED DESCRIPTION

The present description and accompanying drawing FIGURES illustrate the embodiments of an improved coin delivery system, and more particularly a coin delivery system having a temporary holding stack device designed and/or adapted to alleviate the insufficiencies and/or drawbacks associated with existing vending machines. Also provided is a more efficient method and system for operation for a vending machine based on the presently described coin delivery system embodiments. The term vending machine is used in the present disclosure to include any devices and/or systems used for the sales of goods and/or services, including, but not limited to: 1) a device and/or system that accepts payment from a customer, 2) a device and/or system that is operable by a customer, and/or 3) a device and/or system that dispenses one or more goods and/or services selected by the customer. The vending machine is further described here as a device capable of dispensing goods and/or services where the goods can include, but are not limited to foods, beverages, tickets, etc., and where the services can include, but are not limited to coin-operated payphones, etc.

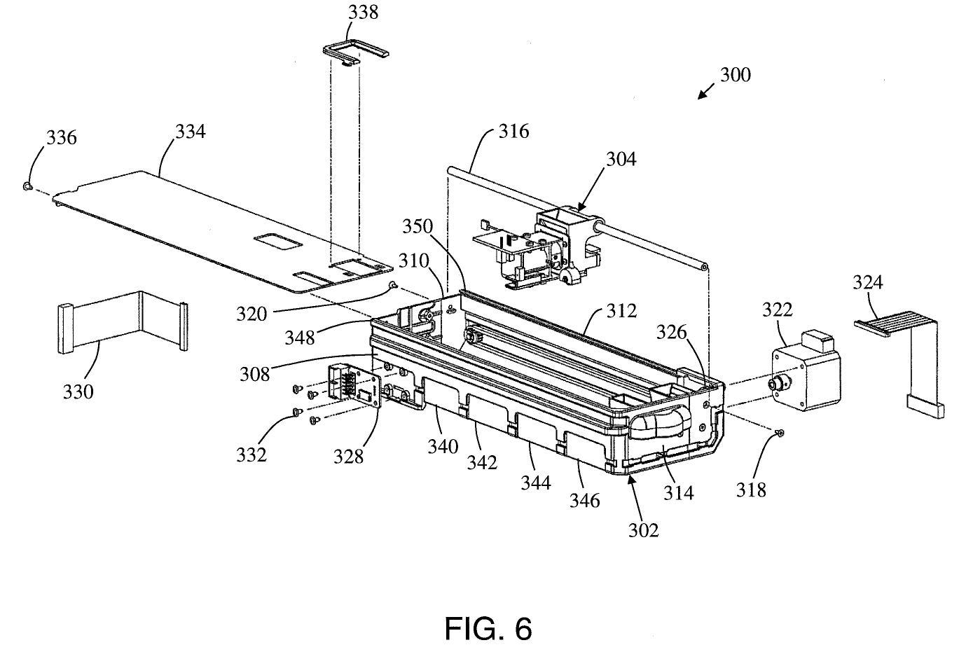

Referring now to FIG. 6, there is provided an exploded-view perspective illustration of an existing coin transport assembly 300 adapted for use in a coin-operated vending machine, said coin transport assembly 300 having an outer casing 302 and a coin carriage assembly 304.

The outer casing 302 of coin transport assembly 300 is illustrated as having a plurality of sidewalls 308, 310, 312, 314 extending upwardly from a bottom wall (not shown), thereby defining an internal cavity and providing an outer casing having a generally rectangular block shape and having an open top end. As also illustrated in FIG. 6, sidewall 308 is illustrated as having a plurality of coin output slots 340, 342, 344, 346 designed to facilitate movement of coins out of the coin transport assembly 300.

A slider shaft 316 is positionable from a first sidewall 314 to a second sidewall 310 of the outer casing 302 of coin transport assembly 300. The slider shaft 316 is typically releasably secured to sidewalls 314, 310 by fasteners 318, 320, respectively. As such, the slider shaft 316 is typically designed to be positionable in the interior cavity of the outer casing 302.

As further illustrated in FIG. 6, the coin carriage assembly 304 is configured to be caused to move along slider shaft 316 by stepper motor assembly 322 having a transport stepper motor harness 324. Stepper motor assembly 322 is illustrated as being positioned outside of the outer casing 302, and releasably secured to a sidewall 312 of outer casing 302 by one or more fasteners 326.

Additionally, an outer surface of a sidewall 308 of outer casing 302 can be configured to accommodate a connector PCB 328 having a transport harness 330. Generally, the connector PCB 328 can be releasably secured to the outer casing 302 by one or more fasteners 332.

With continued reference to FIG. 6, top plate 334 is typically configured to slide over outer casing 302 through channels and/or grooves 348, 350 along the top peripheral edge of sidewalls 308, 312, respectively, thereby covering the outer casing 302 of coin transport assembly 300. Top plate 334 can be releasably secured to the outer casing 302 by one or more fasteners 336 (e.g., screws, etc.). The top surface of top plate 334 can include a coin guide 338 designed to facilitate entrance of a coin into the coin transport assembly 300.

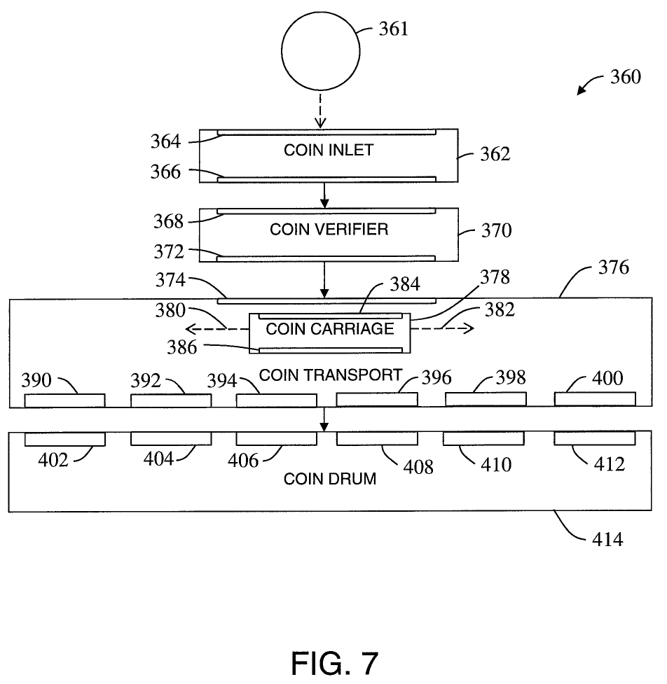

With reference now to FIG. 7, there is provided a perspective illustration of an existing coin delivery system 360. As shown in FIG. 7, the coin delivery system 360 utilizes a coin inlet 362 having a slot 364 sized and shaped to facilitate insertion of a coin 361 through said slot 364 and into the coin inlet 362. The coin inlet 362 is also illustrated as having a slot 366 designed to facilitate movement of coin 361 out of coin inlet 362, through slot 368 of a coin verifier 370, and into coin verifier 370. The coin verifier 370 is illustrated as having a slot 372 designed to facilitate movement of coin 361 from the coin verifier 370, through slot 374 of coin transport 376. Coin transport 376 is illustrated as having a coin carriage 378 movable within the coin transport 376 as indicated by arrows 380, 382. Coin carriage 378 has a slot 384 configured to accept a coin 361 from slot 374 of coin transport 376. Similarly, coin carriage 378 has a slot 386 configured to partially and/or fully align with one or more slots 390, 392, 394, 396, 398, 400 on coin transport 376. Slots 390, 392, 394, 396, 398, 400 are illustrated as being continuous with slots 402, 404, 406, 408, 410, 412 of coin drum 414.

In operation, the coin delivery system 360 can be incorporated into a vending machine. Initially, a coin 361 is inserted through slot 364 of coin inlet 362. The coin 361 can pass through slot 366 of coin inlet 362, and further through slot 368 of coin verifier 370. The coin 361 then passes through slot 372 of coin verifier 370, and further through slot 374 of coin transport 376. Slot 372 of coin verifier 370 is designed to align with slot 374 of coin transport 376, and also with slot 384 of coin carriage 378 when the coin carriage 378 is in its home position. Coin carriage 378 is designed to be caused to move within the coin transport 376 until the coin carriage 378 reaches a position above the required slot. Once the required slot is reached, slot 386 of coin carriage 378 is aligned with the required slot of the coin transport 376 and the coin carriage 378 then drops the coin 1361 through the slot into a coin drum 414. After the coin 361 is dropped, the coin carriage 378 returns to the home position at which time a new coin can be inserted into the coin inlet 362.

The coin delivery system 360 of FIG. 7 further illustrates the complexity and extended time requirement needed during a transaction. Additionally, existing coin delivery systems are susceptible to mechanical failures due to the complexity of moving parts required before the transaction can be completed.

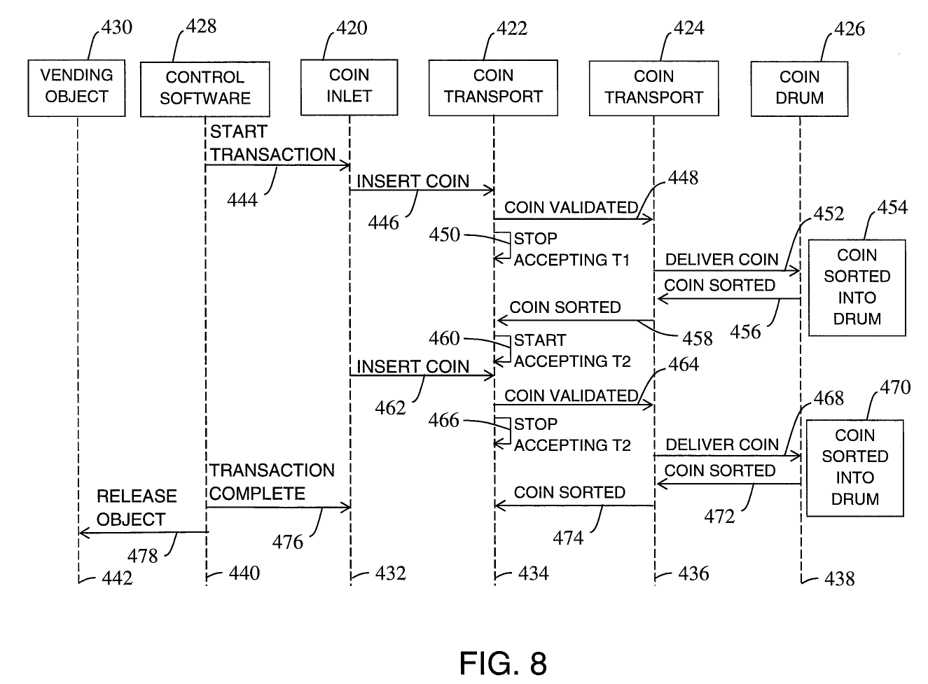

Referring now to FIG. 8, there is provided a sequence of events illustration used by an existing coin delivery system. FIG. 7 illustrates objects labeled coin inlet 420, coin verifier 422, coin transport 424, coin drum 426, control software 428 and vending object 430. FIG. 7 also shows lifelines 432, 434, 436, 438, 440, 442, associated with objects labeled coin inlet 420, coin verifier 422, coin transport 424, coin drum 426, control software 428 and vending object 430, respectively. FIG. 8 further shows messages labeled start transaction 444, coin inserted 446, coin validated 448, top accepting T1 450, deliver coin 452, coin sorted 456, coin sorted 458, start accepting T2 460, coin inserted 462, coin validated 464, stop accepting T2 466, deliver coin 468, coin sorted 472, coin sorted 474, transaction complete 476 and release object 478.

Incorporated in a ticket vending machine, the transaction is started 444 when the control software 428 recognizes insertion of a coin 446 into the coin inlet 420. The inserted coin 446 is then sent to the coin verifier 422 where it is validated 448. As the inserted coin 446 is verified 448, a signal is sent to the coin verifier to stop accepting coins for transaction 1 (T1) 450. After the inserted coin 446 is validated 448, it is sent to the coin transport 424 and further delivered 452 to the coin drum 426 where the coin can be sorted into a coin drum 454. A coin sorted signal 456 is then sent back from the coin drum 426 to the coin transport 424, and a coin sorted signal 458 is further from the coin transport 424 to the coin verifier 422. After the coin verifier 422 receives the coin sorted signal 458 from the coin transport 424, a signal is sent to the coin verifier 422 to start accepting coins for transaction 2 (T2) 460. The transaction can then continue insertion of a coin 462 into the coin inlet 420. The inserted coin 462 is then sent to the coin verifier 422 where it is validated 464. As the inserted coin 462 is validated 464, a signal is sent to the coin verifier 422 to stop accepting coins for transaction 2 (T2) 466. After the inserted coin 462 is validated 464, it is sent to the coin transport 424 and further delivered 468 to the coin drum 426 where the coin can be sorted into a coin drum 470. A coin sorted signal 472 is then sent back from the coin drum 426 to the coin transport 424, and a coin sorted signal 474 is further from the coin transport 424 to the coin verifier 422. After the coin verifier 422 receives the coin sorted signal 474 from the coin transport 424, a signal is sent to the coin verifier 422 to start accepting coins for another transaction (not shown). The process as described above can be repeated as necessary until sufficient funds have been inserted into the machine at which point the control software 428 can then recognize a sufficient monetary value has been inserted, thereby signaling the completion of the transaction 476 to the coin inlet 420.

As further illustrated in FIG. 8, after completion of the transaction 476, the ticket is released 478 from the vending object 430. The sequence of events illustrated in FIG. 7 illustrates that coins can only be inserted after the previously inserted coin has been sorted. Thus, the total time required for the transaction can be extensive. Generally, existing coin delivery systems facilitate the delivery of a coin in up to ten seconds or more. Additionally, the reliance of the system on multiple moving parts for each coin inserted (i.e. each transaction) provides an unnecessary risk for malfunction and/or failure to deliver a ticket.

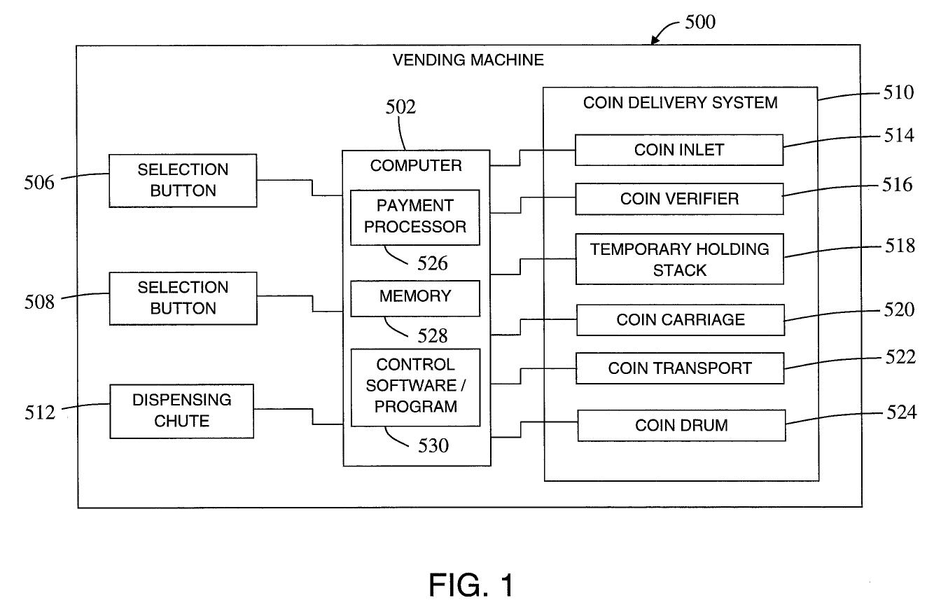

With reference now to FIG. 1, there is illustrated a schematic diagram of a vending machine 500 generally suitable for utilizing one or more aspects of the present disclosure. Vending machine 500 is illustrated as having one or more selection buttons 506, 508 provided such that the customer can select from one of multiple goods, a coin delivery system 510 capable of sorting and storing coins inserted during the transaction, a dispensing chute 512 from which the dispensed good can be removed by a customer, and a computer 502 adapted to access and/or control various components of the vending machine. Other well-known fixtures and/or components of the vending machine may include: a display screen (not shown) for the purpose of displaying information to a customer, such as, for example, information about the goods and or service available through said vending machine, and a change bowl (not shown) provided to return excess, non-conforming, or refunded coins to the customer.

With continued reference to FIG. 1, the coin delivery system 510 is illustrated as further having a coin inlet 514, a coin verifier 516, a temporary holding stack 518, a coin carriage 520, a coin transport 522, and a coin drum 524. The computer 502 has access to and electronic control over the various components of the coin delivery system 510. For example, the computer 502 can access and control: 1) the coin inlet 514 for the purpose of initiating a transaction, 2) the coin verifier 516 to verify the type of coin inserted into the vending machine 500, 3) the temporary holding stack 518, 4) the coin carriage 520, 5) the coin transport 522, and/or 6) the coin drum 524 for the purpose of completing and terminating the transaction. As such, each component of the coin delivery system 510 is in electronic communication with the computer 502. Additionally each of the coin inlet 514, coin verifier 516, temporary holding stack 518, coin carriage 520, coin transport 522, and coin drum 524 of the coin delivery system 510 can be electrically connected (not shown). As such, the efficiency of the coin delivery system 510 can be increased. Similarly, the selection buttons 506, 508 and the dispensing chute 512 can be electronically connected to the computer 502 for operation or access by computer 502.

Computer 502 typically has one or more components including a payment processor 526 for the purpose of calculating whether the customer inserted too much money, not enough money, or the correct amount of money. In addition, the computer 502 also generally has access and control over a data storage means and/or memory 528, such as, for example, local RAM, hard disk, CD-ROM, DVD, etc., provided to store various types of information and/or data from components of the vending machine. Furthermore, the computer 502 also has a computer program 530 providing the method for completing the transaction. The control software 530 is typically designed to selectively connect the computer 502 to the components of the coin delivery system 510 and is typically adapted to selectively control the components of the coin delivery system 510

As such, computer 502 can be provided as a control means capable of accessing and operatively controlling the coin identification device, the coin temporary holding device, and/or the coin sorting device. The computer 502 can be operatively connected to a component of the coin delivery system 510 and programmed to perform the transaction of inserted coins to the delivery of the good or service by operations including: initiating the transaction upon insertion of coins into the coin inlet 514 of coin delivery system 510, processing the inserted coins using the coin delivery system 510, and/or completing the transaction once a predetermined fee has been inserted into the coin delivery system 510, thereby dispensing the good and/or service from the vending machine 502. Additionally, the computer 502 can be programmed to: record the denomination of the coin inserted into the coin delivery system 510 in data storage means and/or memory 528; record the coin holding unit of the temporary holding stack 518 holding the inserted coin in data storage means and/or memory 528; and/or electronically signaling the components of the coin delivery system 510 to sort the inserted coins using the data recorded in the data storage means and/or memory 528.

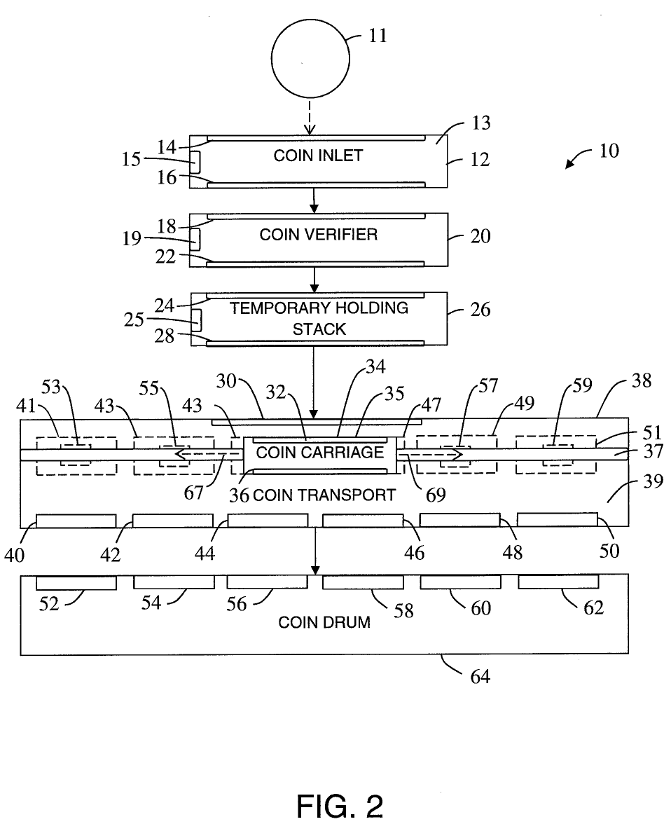

With reference now to FIG. 2, there is provided a perspective illustration of a coin delivery system 10 in accordance with one embodiment of the present disclosure.

As shown in FIG. 2, the coin delivery system 10 utilizes a coin inlet 12 having a coin input slot 14 sized and shaped to facilitate insertion of a coin 11 through said coin input slot 14. Coin inlet 12 is not limited by size, shape or material. Generally, coin inlet 12 has a hollow internal cavity 13 designed to facilitate the passage of coin 11 therethrough. Coin inlet 12 can also be configured to have a sensor 15 mounted to an inner surface thereof for the purpose of identifying, for example, whether the inserted object and/or coin is counterfeit. Coin inlet 12 is also illustrated as having a coin output slot 16 designed to facilitate movement of coin 11 from the internal cavity 13 of coin inlet 12, and further through coin input slot 18 of coin verifier 20.

Coin verifier 20 can also be configured to have a sensor 19 mounted to an inner surface thereof for the purpose of: 1) identifying whether an inserted object and/or coin has monetary value for the purpose of preventing counterfeit payment, 2) preventing non-monetary objects from being accepted as forms of payment, and/or 3) identifying the monetary value of the coins as they are inserted into the coin delivery system. As such, inadequate objects can be removed, adequate objects can be accepted, and the accepted objects can be identified and recorded by coin verifier 20. Coin verifier 20 is illustrated as having a coin output slot 22 designed to facilitate movement of coin 11 from the internal cavity 19 of coin verifier 20, and further through slot 24 of temporary holding stack 26.

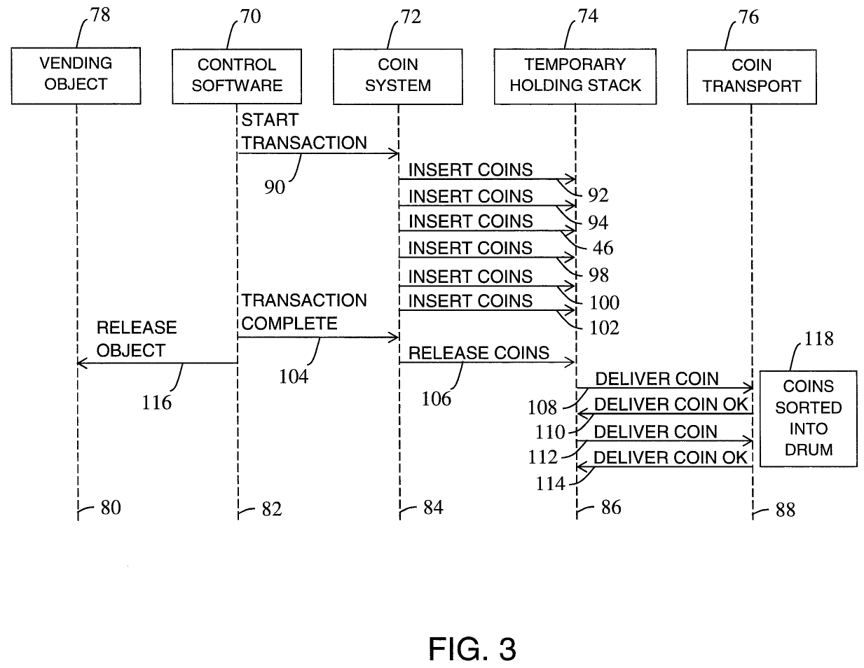

The temporary holding stack 26 (described in further detail later with reference to FIGS. 3-5) is illustrated as having a coin input slot 24 and as being configured to store and/or hold the one or more coins 11 entered in the transaction. Temporary holding stack 26 can also be configured to have a sensor 25 mounted to an inner surface thereof. In one non-limiting embodiment, the temporary holding stack 26 is designed to hold one or more coins for one or more transactions. Temporary holding stack 26 is also illustrated as having a coin output slot 28 continuous with coin input slot 30 of coin transport 38.

Coin transport 38 is illustrated as having a coin input slot 30 and one or more coin output slots 40, 42, 44, 46, 48, 50. Coin transport 38 is not limited in size, shape, or material. Generally, coin transport 38 has a hollow internal cavity 39. Coin transport 38 is also illustrated as having a slider shaft 37 extending from a first side to a second side thereof. Slider shaft 37 is designed to facilitate the movement of coin carriage 34 between several positions within the internal cavity 39 of coin transport 38. The home position 35 of coin carriage 34 can optionally be defined as a position wherein at least a majority of the coin input slot 32 of coin carriage 34 is positioned underneath coin input slot 30 of coin transport 38. The coin carriage 34 can be caused to move by a motor (not shown) to one or more release positions 41, 43, 45, 47, 49, 51, said release positions generally corresponding with coin output slots 40, 42, 44, 46, 48, 50 of coin transport 38, respectively. The home position 35 of coin transport 38 can have a sensor (not shown) for the purpose of 1) detecting the position of coin carriage 34 within coin transport 38, and/or 2) determining the presence of coin carriage 34 in home position 35. Similarly, release positions 41, 43, 45, 47, 49, 51 of coin transport 38 can have a sensor 53, 55, 57, 59, 61, 63 for the purpose of 1) detecting the position of coin carriage 34 within coin transport 38, and/or 2) determining the presence of coin carriage 34 in release positions 41, 43, 45, 47, 49, 51, respectively.

As indicated by arrows 67, 69, coin carriage 34 can be designed to be caused to move linearly along slider shaft 37. Coin carriage 34 has a coin input slot 32 sized and shaped to facilitate insertion of a coin 11 through said coin input slot 32. Similarly, coin carriage 34 has a coin output slot 36 designed to facilitate release of the coin out of coin carriage 34. Generally, coin carriage 34 is designed to 1) receive a coin 11 through coin input slot 32, 2) temporarily hold the coin 11 as the coin carriage 34 is moved along slider shaft 37, and/or 3) release coin 11 through coin output slot 36 when coin carriage 34 reaches its final destination along slider shaft 37. The final destination of coin carriage 34 can be one or more of release positions 41, 43, 45, 47, 49, 51 such that coin output slot 36 of coin carriage 34 is partially and/or fully aligned with coin output slots 40, 42, 44, 46, 48, 50 of coin transport 38, respectively.

Coin carriage 34 can have a sensor (not shown) for the purpose of 1) detecting whether or not a coin is present in coin carriage 34, 2) determining the position of coin carriage 34 within the internal cavity 39 of coin transport 38, and/or 3) determining whether coin carriage 34 is present in home position 35 and/or release positions 41, 43, 45, 47, 49, 51. As such, as coin 11 is released from coin carriage 34 through coin output slots 40, 42, 44, 46, 48, 50 of coin transport 38, the coin is moved through coin input slots 52, 54, 56, 58, 60, 62 of coin drum 64, respectively.

As illustrated in FIG. 2, coin drum 64 can be configured to have a different coin input slot for each type of coin 11 (e.g., pennies, nickels, dimes, quarters, etc.). In one embodiment, coin input slots 52, 54, 56, 58, 60, 62 of coin drum 64 can open into reservoirs (not shown), said reservoirs being specific for the inserted coin type. For example, in such a configuration, coin input slot 52 can open into a reservoir specific for pennies, coin input slot 54 can open into a reservoir specific for nickels, coin input slot 56 can open into a reservoir specific for dimes, coin input slot 58 can open into a reservoir specific for quarters, coin input slot 60 can open into a reservoir specific for half-dollars, and coin input slot 62 can open into a reservoir specific for dollar coins. In another and/or alternative embodiment, each coin input slot 52, 54, 56, 58, 60, 62 can open into a single reservoir (not shown) wherein all inserted coins are held together. In other embodiments, coin drum 64 can be configured to have a single coin input slot designed to facilitate movement of all coin types from the coin transport 38 to the coin drum 64.

Coin delivery system 10 is suitable for use in various types of vending machine transactions wherein one or more coins are inserted into said vending machine by way of payment. Typically, the vending machine is designed to dispense a good, such as, for example, a parking ticket, or a service to the paying customer. In operation, a coin 11 is inserted through coin input slot 14 of coin inlet 12. The coin 11 can pass through coin output slot 16 of coin inlet 12, and further through coin input slot 18 of coin verifier 20 where the inserted coin 11 can be verified by coin verifier 20. After the inserted coin 11 is verified, the coin 11 passes through coin output slot 22 of coin verifier 20, and further through coin input slot 24 of the temporary holding stack, said temporary holding stack being designed to temporarily hold the inserted coins during the transaction. Once the required input (i.e. the correct monetary value of a plurality of coins 11 required to purchase the good or service) is received by the vending machine, the transaction is rendered complete and the coins 11 can be released from the temporary holding stack 26. The coins 11 are released through coin output slot 28 of temporary holding stack 26, and further passed through coin input slot 30 of coin transport 38 and coin input slot 32 of coin carriage 34 when coin carriage 34 is positioned in its home position 35. Once the coin 11 is loaded in the coin carriage 34, the coin carriage 34 can be caused to move by a motor (not shown) to one or more release positions 41, 43, 45, 47, 49, 51. Typically, each release position 41, 43, 45, 47, 49, 51 corresponds to a coin output slot 40, 42, 44, 46, 48, 50 on coin transport 38. For example, slot output slot 40 of coin transport 38 can lead to a coin input slot 52 of coin drum 64 designed to facilitate movement of pennies into coin drum 64. As such, if a penny is carried in coin carriage 34, the coin carriage would be caused to move to release position 41 positioned directly above coin output slot 40 of coin transport 38. Each time the coin carriage 34 of coin transport 38 returns to the home position 35, another coin can be released from the temporary holding stack 26 and into coin carriage 34 to be delivered to the coin drum 64.

The coin delivery system 10 of the present disclosure is capable of facilitating a coin 11 inserted by a user to reach its end destination in from about 0.10 seconds to about 2.00 seconds, more typically from about 0.20 seconds to about 1.20 seconds, and still more typically from about 0.30 seconds to about 1.05 seconds. In one non-limiting embodiment, the coin delivery system 10 of the present disclosure is capable of facilitating a coin 11 inserted by a user to reach its end destination in less than about 1 second. Generally, the pace of the sorting of identified coins has no effect on the identifying and verifying of the inserted coins.

As illustrated in FIG. 2, the temporary holding stack 26 is positioned after the coin verifier 20 and before the coin transport 38. However, the temporary holding stack 26 can be positioned between other or alternative components of the coin delivery system, such as, for example, between the coin inlet 12 and the coin verifier 20. In embodiments where the temporary holding stack is positioned between the coin verifier and the coin transport (as illustrated in FIG. 1 of the present disclosure), several advantages are provided including, but not limited to: 1) the efficiency of the coin delivery system is increased; and/or, 2) there is no reliance on the moving parts of the coin transport or the transport motor during the transaction.

With continued reference to FIG. 2, the coin inlet 12 is typically disposed upstream (i.e. prior to) the coin verifier 20. The coin verifier 20 is typically disposed downstream (i.e. after) the coin inlet 12 and upstream (i.e. prior to) the temporary holding stack 26. The temporary holding stack 26 is typically disposed downstream (i.e. after) the coin verifier 20 and upstream (i.e. prior to) the coin transport 38. The coin transport 38 is typically disposed downstream (i.e. after) of the temporary holding stack 26 and upstream (i.e. prior to) the coin carriage 34. The coin drum is typically provided downstream (i.e. after) the coin inlet 12, coin verifier 20, temporary holding stack 26, coin transport 38, and coin carriage 34.

Referring now to FIG. 3, there is provided a sequence of events illustration used by a vending machine having a coin delivery system in accordance with one embodiment of the present disclosure. FIG. 3 illustrates objects labeled control software 70, coin system 72, temporary holding stack 74, coin transport 76 and vending object 78. FIG. 3 also shows lifelines 82, 84, 86, 88, 80, associated with objects labeled control software 70, coin system 72, temporary holding stack 74, coin transport 76 and vending object 78, respectively. FIG. 3 further shows messages labeled start transaction 90, insert coins 92, insert coins 94, insert coins 96, insert coins 98, insert coins 100, insert coins 102, transaction complete 104, release coins 106, deliver coin 108, deliver coin OK 110, deliver coin 112, deliver coin OK 114, and release object 116.

The sequence of events illustrated in FIG. 3 is suitable for use in a coin delivery system incorporated in a vending machine, for example, a parking ticket vending machine. As such, a transaction is started 90 when the control software 70 recognizes insertion of one or more coins 92, 94, 96, 98, 100, 102 into the coin delivery system 72. The inserted coins 92, 94, 96, 98, 100, 102 are held by the temporary holding stack 74 until the correct monetary value has been inserted into the vending machine. The control software 70 can then recognize a sufficient monetary value has been inserted, thereby signaling the completion of the transaction 104 to the coin delivery system 72, wherein the temporary holding stack 74 then releases the coins 106 into the coin transport 76. As indicated by deliver coin 108, deliver coin OK 110, deliver coin 112 and deliver coin OK 114, the coins can be sorted 118 into the coin drums in a one-by-one fashion.

As illustrated in FIG. 3, after completion of the transaction 104, the coins can be released 106 concurrently with the release of an object 116 from the vending object 78. Thus, the total time required for the transaction can be significantly reduced, and the throughput of the end-to-end user experience can be enhanced. As also illustrated in FIG. 3, the coin delivery system is capable of performing the transaction 104 separate from the sorting 118 of inserted coins into coin drums. As such, the overall efficiency of the coin delivery system is improved.

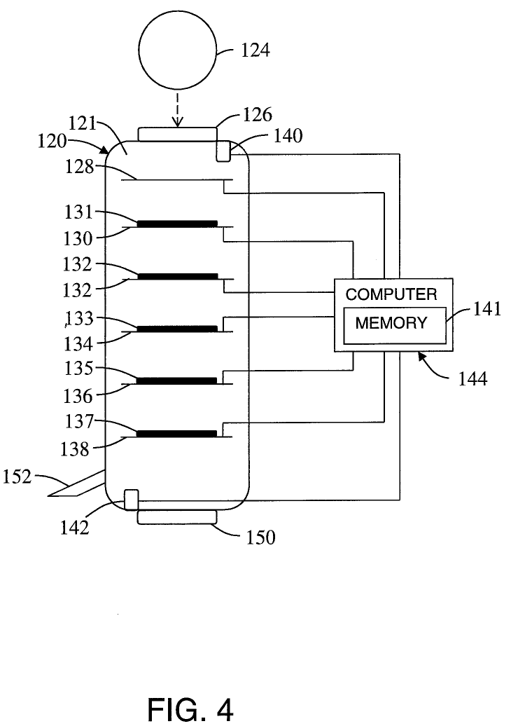

With reference now to FIG. 4, there is provided a cross-sectional perspective illustration of a temporary holding stack device in accordance with the present disclosure. The temporary holding stack 120 of FIG. 4 can be used as a component of a coin delivery system of a vending machine (see FIGS. 2-3). The temporary holding stack 120 is illustrated in FIG. 4 as having a generally cylindrical shape, and as having a generally rectangular cross-sectional shape; however, the temporary holding stack can have other or alternative shapes. Furthermore, temporary holding stack 120 is illustrated as having a hollow interior, thereby providing an interior cavity 121. The size of the internal cavity 121 is typically selected to accommodate various sized coins 124 of differing diameters (e.g., pennies, nickels, dimes, quarters, etc.) inserted into the vending machine. In the embodiment illustrated in FIG. 4, the size of the internal cavity 121 is constant throughout the length of the temporary holding stack 120. In another and/or alternative embodiment, the size of the internal cavity 121 varies along the length of the temporary holding stack. As also illustrated in FIG. 4, the temporary holding stack has a height greater than its width, thereby providing a temporary holding stack in a substantially vertical orientation capable of temporarily holding a stack of inserted coins.

An upper portion of the temporary holding stack 120 is illustrated as having a coin input slot 126. Coin input slot 126 is shaped and sized to facilitate the passage of one or more coins 124 into the temporary holding stack 120. In one embodiment, coin input slot 126 is configured to permit only one coin to pass through said coin input slot 126, thereby decreasing the possibility of jams within the temporary holding stack 120 due to too many coins. Similarly, a lower portion of temporary holding stack 120 is illustrated as having a coin output slot 150. Coin output slot 150 is shaped and sized to facilitate the passage of one or more coins 124 out of the temporary holding stack 120. In one embodiment, similar to the coin input slot 126, coin output slot 150 is configured to permit only one coin to pass therethrough. Furthermore, an exterior portion of the temporary holding stack 120 can include a transaction abort chute 152 designed to return rejected and/or refunded coins back to a customer.

With continued reference to FIG. 4, the temporary holding stack is illustrated as having a plurality of coin holding units 128, 130, 132, 134, 136, 138 provided in the interior cavity 121 of the temporary holding stack 120. The shape, size and configuration of each coin holding unit 128, 130, 132, 134, 136, 138 is non-limiting, and is typically selected to maximize coin-holding characteristics. As illustrated in FIG. 4, each coin holding unit 128, 130, 132, 134, 136, 138 is illustrated as having the same or similar size and shape. Generally, each of the coin holding unit 128, 130, 132, 134, 136, 138 is configured to be spaced apart and to facilitate the temporary holding of a plurality of coins 124, 131, 133, 135, 137 inserted into the temporary holding stack 120.

The coin input slot 126 of temporary holding stack 120 can facilitate insertion of a coin from vertical, oblique, and/or horizontal angles. As illustrated in FIG. 4, coin 124 is being inserted into the temporary holding stack 120 from a generally vertical position such that the coin 124 is entered in a vertical orientation. However, the coin input slot 126 can facilitate coins inserted from other or alternative angles. Generally, the temporary holding stack 120 is configured to temporarily hold the coins 131, 133, 135, 137 in a horizontal orientation in the interior cavity 121 of temporary holding stack 120. As such, the coin input slot 126 can include a device or structure (not shown) for the purpose of moving the inserted coin from a variety of angles to a generally horizontal orientation to be temporarily held by a coin holding unit. Additionally, the temporary holding stack 120 is illustrated as being configured to temporarily hold the coins in isolation from other coins which are inserted during the same transaction. In another and/or alternative embodiment, the coins can be held in the temporary holding stack 120 such that each inserted coin is held in contact with the other coins received during the transaction, thereby saving space in the temporary holding stack such that more coins can be added per transaction.

In operation, as the one or more coins pass through coin input slot 126 of temporary holding stack 120, the type of coin type can be identified and recorded by a sensor 140 positioned at or near coin input slot 126. Similarly, as the one or more coins pass through coin output slot 150 of temporary holding stack 120, the coin can be recorded by a sensor 142 positioned at or near coin output slot 150. Sensors 140, 142 of temporary holding stack 120 can be provided for the purpose of, but not limited to 1) detecting whether or not a coin is present in the temporary holding stack, 2) identifying whether the inserted coin has monetary value for the purpose of identifying counterfeit money, 3) preventing non-monetary objects from being accepted as forms of payment, 4) verifying or validating the inserted coins, and/or 5) identifying the monetary value of the coins as the coins are inserted into the temporary holding stack device. As such, when the temporary holding stack 120 of the present disclosure is used as part of a vending machine coin delivery system, the temporary holding stack 120 can be used in place of traditional coin inlets (see 12 of FIG. 2) and/or coin verifiers (see 20 of FIG. 2). This is advantageous because without a coin inlet and/or coin verifier, the transaction time can be significantly decreased and there is less of a reliance on other system components.

With continued reference to FIG. 4, each coin holding unit 128, 130, 132, 134, 136, 138 can be connected to a computer 144 for the purpose of identifying and recording the number of the coin holding unit the inserted coins 124, 131, 133, 135, 137 are temporarily held in during the transaction. Similarly, sensor 140 and sensor 142 can be connected to a computer 144. As such, at least the 1) type of coin (i.e. denomination), and/or 2) the coin holding unit, of each coin temporarily held by the temporary holding stack 120 is recorded and saved in the memory 141 of the computer 144. When a transaction is completed (as illustrated in the sequence of events in FIG. 3), the temporary holding stack 120 is configured to receive signals from the computer 144 instructing the temporary holding stack 120 to begin releasing coins into the coin transport (not shown).

The temporary holding stack 120 is generally configured to have an electro-mechanical coin handling mechanism (not shown) designed to accept a plurality of coins inserted by way of payment into the vending machine. In operation, as illustrated in FIG. 4, a coin 124 is inserted into temporary holding stack 120 through coin input slot 126. The temporary holding stack 120 can shuffle the coin 124 down through the interior cavity 121 of the temporary holding stack 120 until the coin is stopped and/or temporarily held by one of a plurality of coin holding units 128, 130, 132, 134, 136, 138. Once coin 124 is inserted through coin input slot 126 of temporary holding stack 120, coin 124 will be temporarily held by coin holding unit 128. As illustrated in FIG. 4, each coin holding units 128, 130, 132, 134, 136, 138 of the temporary holding stack 120 temporarily holds coins 124, 131, 133, 135, 137, respectively.

The temporary holding stack 120 operates in a first-in, first-out array of received coins such that when one coin is inserted through coin input slot 126, one or more coins held by the one or more coin holding units 128, 130, 132, 134, 136, 138 are caused to shuffle downwards through the interior cavity 121 of the temporary holding stack 120. As such, the order in which coins are inserted into the temporary holding stack 120 can be the same as the order in which coins are released from coin output slot 150 of temporary holding stack 120. The information recorded in the memory 141 of computer 144 can be used by a control software (see FIG. 2) for the purpose of instructing the coin transport (not shown) positionable below the temporary holding stack 120. As such, the efficiency of the coin delivery system can be substantially increased. This is advantageous because the control software associated with the coin delivery system can know which coin releasing position to instruct the coin carriage to move to (see FIG. 2).

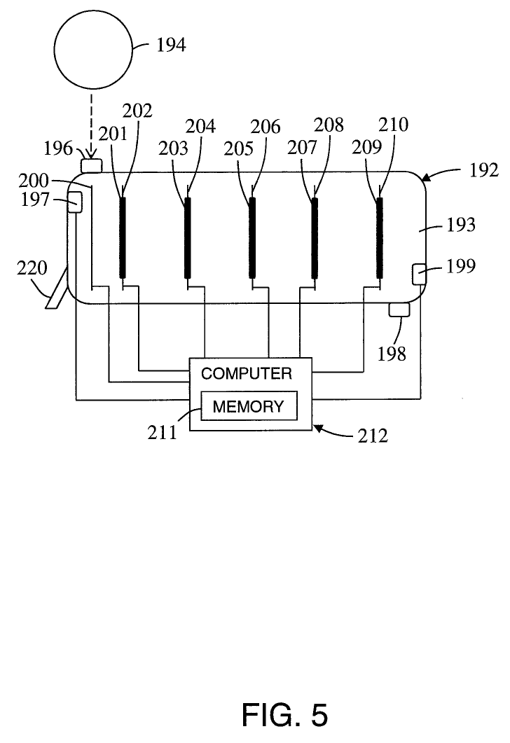

With reference now to FIG. 5, there is provided a cross-sectional perspective illustration of a temporary holding stack device in accordance with the present disclosure. The temporary holding stack 192 of FIG. 5 can be used as a component of a coin delivery system of a vending machine (see FIGS. 2-3). The temporary holding stack 192 is illustrated in FIG. 5 as having a generally cylindrical shape, and as having a generally rectangular cross-sectional shape; however, the temporary holding stack can have other or alternative shapes. Furthermore, temporary holding stack 192 is illustrated as having a hollow interior, thereby providing an interior cavity 193. The size of the internal cavity 193 is typically selected to accommodate various sized coins 194 of differing diameters (e.g., pennies, nickels, dimes, quarters, etc.) inserted into the vending machine. In the embodiment illustrated in FIG. 5, the size of the internal cavity 193 is constant throughout the length of the temporary holding stack 192. In another and/or alternative embodiment, the size of the internal cavity 193 varies along the length of the temporary holding stack 192. As also illustrated in FIG. 5, the temporary holding stack has a width greater than its height, thereby providing a temporary holding stack in a substantially horizontal orientation capable of temporarily holding a stack of inserted coins.

An upper portion of the temporary holding stack 192 is illustrated as having a coin input slot 196. Coin input slot 196 is shaped and sized to facilitate the passage of one or more coins 194 into the temporary holding stack 192. In one embodiment, coin input slot 196 is configured to permit only one coin to pass through said coin input slot 196, thereby decreasing the possibility of jams within the temporary holding stack 192 due to too many coins. Similarly, a lower portion of temporary holding stack 192 is illustrated as having a coin output slot 198. Coin output slot 198 is shaped and sized to facilitate the passage of one or more coins 194 out of the temporary holding stack 192. In one embodiment, similar to the coin input slot 196, coin output slot 198 is configured to permit only one coin to pass therethrough. Furthermore, an exterior portion of the temporary holding stack 192 can include a transaction abort chute 220 designed to return rejected and/or refunded coins back to a customer.

With continued reference to FIG. 5, the temporary holding stack is illustrated as having a plurality of coin holding units 200, 202, 204, 206, 208, 210 provided in the interior cavity 193 of the temporary holding stack 192. The shape, size and configuration of each coin holding unit 200, 202, 204, 206, 208, 210 is non-limiting, and is typically selected to maximize coin-holding characteristics. As illustrated in FIG. 5, each coin holding unit 200, 202, 204, 206, 208, 210 is illustrated as having the same or similar size and shape. Generally, each of the coin holding unit 200, 202, 204, 206,.208, 210 is configured to facilitate the temporary holding of a plurality of coins 194, 201, 203, 205, 207, 209 inserted into the temporary holding stack 192.

The coin input slot 196 of temporary holding stack 192 can facilitate insertion of a coin from vertical, oblique, and/or horizontal angles. As illustrated in FIG. 5, coin 194 is being inserted into the temporary holding stack 192 from a generally vertical position such that the coin 194 is entered in a vertical orientation. However, the coin input slot 196 can facilitate coins inserted from other or alternative angles. Generally, the temporary holding stack 192 is configured to temporarily hold the coins in a vertical orientation in the interior cavity 193 of temporary holding stack 192. As such, the coin input slot 196 can include a device or structure (not shown) for the purpose of moving the inserted coin from a variety of angles to a generally horizontal orientation to be temporarily held by a coin holding unit. One non-limiting advantage of the horizontal orientation of temporary holding stack 192 is that the one or more coins are held in a vertical orientation in the interior cavity 193 of the temporary holding stack 192. This is advantageous because it is not required to flip or otherwise manipulate the coin to an alternative position before the coin is released from the temporary holding stack. Additionally, the temporary holding stack 192 is illustrated as being configured to temporarily hold the coins in isolation from other coins which are inserted during the same transaction. In another and/or alternative embodiment, the coins can be held in the temporary holding stack 192 such that each inserted coin is held in contact with the other coins received during the transaction, thereby saving space in the temporary holding stack such that more coins can be added per transaction.

In operation, as the one or more coins pass through coin input slot 196 of temporary holding stack 192, the type of coin type can be identified and recorded by a sensor 197 positioned at or near coin input slot 196. Similarly, as the one or more coins pass through coin output slot 198 of temporary holding stack 192, the coin can be recorded by a sensor 199 positioned at or near coin output slot 198. Sensors 197, 199 of temporary holding stack 192 can be provided for the purpose of, but not limited to 1) detecting whether or not a coin is present in the temporary holding stack, 2) identifying whether the inserted coin has monetary value for the purpose of identifying counterfeit money, 3) preventing non-monetary objects from being accepted as forms of payment, 4) verifying or validating the inserted coins, and/or 5) identifying the monetary value of the coins as the coins are inserted into the temporary holding stack device. As such, when the temporary holding stack 192 of the present disclosure is used as part of a vending machine coin delivery system, the temporary holding stack 192 can be used in place of traditional coin inlets (see 12 of FIG. 2) and/or coin verifiers (see 20 of FIG. 2). This is advantageous because without a coin inlet and/or coin verifier, the transaction time can be significantly decreased and there is less of a reliance on other system components.

With continued reference to FIG. 5, each coin holding unit 200, 202, 204, 206, 208, 210 can be connected to a computer 212 for the purpose of identifying and recording the number of the coin holding unit 200, 202, 204, 206, 208, 210 the inserted coins 194, 201, 203, 205, 207, 209 are temporarily held in during the transaction. Similarly, sensor 197 and sensor 199 can be connected to a computer 212. As such, at least the 1) type of coin (i.e. denomination), and/or 2) the coin holding unit, of each coin temporarily held by the temporary holding stack 192 is recorded and saved in the memory 211 of the computer 212. When a transaction is completed (as illustrated in the sequence of events in FIG. 3), the temporary holding stack 192 is configured to receive signals from the computer 212 instructing the temporary holding stack 192 to begin releasing coins into the coin transport (not shown).

The temporary holding stack 192 is generally configured to have an electro-mechanical coin handling mechanism (not shown) designed to accept a plurality of coins inserted by way of payment into the vending machine. In operation, as illustrated in FIG. 5, a coin 194 is inserted into temporary holding stack 192 through coin input slot 196. The temporary holding stack 192 can shuffle the coin 194 down through the interior cavity 193 of the temporary holding stack 192 until the coin is stopped and/or temporarily held by one of a plurality of coin holding units 200, 202, 204, 206, 208, 210. Once coin 194 is inserted through coin input slot 196 of temporary holding stack 192, coin 194 will be temporarily held by coin holding unit 200. As illustrated in FIG. 5, each coin holding units 200, 202, 204, 206, 208, 210 of the temporary holding stack 192 temporarily holds coins 194, 201, 203, 205, 207, 209, respectively.

Generally, the temporary holding stack 192 operates in a first-in, first-out array of received coins such that when one coin is inserted through coin input slot 196, one or more coins held by the one or more coin holding units 200, 202, 204, 206, 208, 210 are caused to shuffle downwards through the interior cavity 193 of the temporary holding stack 192. As such, the order in which coins are inserted into the temporary holding stack 192 can be the same as the order in which coins are released from coin output slot 198 of temporary holding stack 192. The information recorded in the memory 211 of computer 212 can be used by a control software (see FIG. 2) for the purpose of instructing the coin transport (not shown) positionable below the temporary holding stack 192. As such, the efficiency of the coin delivery system can be substantially increased. This is advantageous because the control software associated with the coin delivery system can know which coin releasing position to instruct the coin carriage to move to (see FIG. 2).

Generally, the coin delivery system according to various embodiments of the present disclosure (as illustrated in FIGS. 2-5 and/or as described above) decouples the user transaction from the coin sorting such that the user transaction. As such, mechanical failures are far less likely to leave a customer without a ticket and/or refunded coins because of mechanical failure while delivering a particular coin. Similarly, the coin delivery system is much less error-prone to jamming by removing the reliance on moving parts and sensors during the user transaction. Thus, there is provided an effectively error-free transaction that succeeds through to delivery of an object, such as, for example, a parking ticket. The sorting of the coins into coin drums can then happen in parallel with the printing and delivery of the ticket. As such, the presently described coin delivery system provides an added advantage in that throughput of the end-to-end user experience is enhanced.

Other and/or alternative non-limiting advantages of the coin delivery system of the present disclosure include, but are not limited to:

1) a reduction in transaction time of end-to-end purchase of an object because there is no need to wait for the coin to get from the customers hand into a specific drum, via a transport mechanism which is prone to failure if the motor is driven hard;

2) there is no need to continually start and stop the transport delivery motor during the actual transaction;

3) each coin which is entered presents little to no risk of jamming;

4) there is no need to inhibit the verifier device while a coin is being delivered, thereby providing an improved throughput and less rejected coins; and,

5) the motor speeds required to drive the coin transport do not need to be overly aggressive in order to meet delivery criteria, thereby reducing the risk of motor stalls.

It will be appreciated that the variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for delivering coins during a vending machine transaction, said coins inserted by way of payment, and said vending machine designed to dispense a good or service, the coin delivery system comprising:
a coin identification device capable of identifying and verifying an inserted coin type;
a coin temporary holding device disposed downstream of the coin identification device and capable of temporarily holding an identified coin received from the coin identification device; and,
a coin sorting device disposed downstream of the coin temporary holding device and capable of sorting the identified coin held by the coin temporary holding device,
whereby a pace of sorting an identified coin has no effect on the identifying and verifying of inserted coins.

2. The system of claim 1 wherein the coin delivery system is capable of performing a user transaction separate from the sorting of inserted coins by the coin sorting device.

3. The system of claim 1 further comprising:
a control means capable of accessing and controlling the coin identification device, the coin temporary holding device, and/or the coin sorting device.

4. The system of claim 2 wherein the control means further comprises:
a computer operatively connected to a component of the coin delivery system and programmed to perform the transaction of inserted coins to the delivery of the good or service by operations including:
initiating the transaction upon insertion of coins into the coin delivery system;
processing the inserted coins using the coin delivery system; and,
completing the transaction once a predetermined fee has been inserted into the coin delivery system, thereby dispensing the good or service.

5. The system of claim 3 wherein the computer further comprises:
control software designed to selectively connect the computer to the component of the coin delivery system and adapted to selectively control the component of the coin delivery system; and,
a data storage means operatively connected to the component of the coin delivery system.

6. The system of claim 4 wherein the computer is further programmed to:
record the denomination of the coin inserted into the coin delivery system in said data storage means;
record the coin holding unit of the temporary holding stack device holding the inserted coin in said data storage means; and,
electronically signal the coin sorting device to sort the inserted coins using the data recorded in the data storage means.

7. The system of claim 1 wherein the identification device further comprises:
a coin input having a coin input slot into which coins are inserted, said coin inlet also having a coin output slot;
a coin verifier having a coin input slot connected to the coin output slot of the coin input and adapted to verify the inserted coins, said coin verifier having a coin output slot; and,
sensors positionable in said coin input and coin verifier, said sensors capable of identifying and recording the type of coin inserted into the coin delivery system.

8. The system of claim 1 wherein the temporary holding device further comprises:
a temporary holding stack device having a coin input slot connected to the coin output slot of the coin verifier and an internal cavity adapted to temporarily hold the inserted coins during the transaction, said temporary holding stack having a coin output slot.

9. The system of claim 8 wherein the temporary holding stack device further comprises:
coin holding units spaced apart and positionable within the internal cavity of the temporary holding stack and adapted to hold the coins inserted during the transaction; and,
sensors positionable in said temporary holding stack device, said sensors capable of identifying and recording the type of coin inserted into the temporary holding stack, wherein the coin holding unit of the temporary holding stack device temporarily holds the coin.

10. The system of claim 1 wherein the sorting device further comprises:
a coin transport having a coin input slot connected to the coin output slot of the temporary holding stack and adapted to facilitate the transport of coins from the temporary holding stack, said coin transport having at least one coin output slot; and,
a coin drum having at least one coin input slot connected to the at least one coin output slot of the coin transport and adapted to receive and store coins from the coin transport.

11. The system of claim 10 wherein the coin transport further comprises:
a coin carriage having a coin input slot and adapted to carry a coin, said coin carriage having a coin output slot;
a slider shaft positionable in the coin transport and adapted to facilitate movement of the coin carriage within the coin transport; and,
a stepper motor operatively connected to said coin carriage capable of causing said coin carriage to move along said slider shaft.

12. A system for delivering coins during a vending machine transaction, said coins inserted by way of payment, and said vending machine designed to dispense a good or service, the coin delivery system comprising:
a coin inlet having a coin input slot into which coins are inserted, said coin inlet also having a coin output slot;
a coin verifier having a coin input slot connected to the coin output slot of the coin input and adapted to verify the inserted coins, said coin verifier having a coin output slot;
a temporary holding stack device having a coin input slot connected to the coin output slot of the coin verifier and an internal cavity adapted to temporarily hold the inserted coins during the transaction, said temporary holding stack having a coin output slot;
a coin transport having a coin input slot connected to the coin output slot of the temporary holding stack and adapted to facilitate the transport of coins from the temporary holding stack, said coin transport having at least one coin output slot; and,
a coin drum having at least one coin input slot connected to the at least one coin output slot of the coin transport and adapted to receive and store coins from the coin transport,
wherein said temporary holding stack device further comprises one or more coin holding units spaced apart and positionable within the internal cavity of the temporary holding stack device and adapted to hold the coins inserted during the transaction after verification by the coin verifier and prior to reception in the coin drum.

13. The system of claim 12 further comprising:
sensors positionable in the coin inlet, coin verifier, temporary holding stack device, coin transport, and coin drum of said coin delivery system, said sensors capable of identifying and recording the type of coin inserted into the coin delivery system and the coin holding unit of the temporary holding stack device temporarily holding the coin.

14. The system of claim 12 further comprising:
a computer connected to the components of the coin delivery system, said computer comprising:
a control software designed to selectively connect the computer to the components of the coin delivery system and adapted to operatively control the said components of the coin delivery system, and,
a data storage means connected to the components of the coin delivery system.

15. The system of claim 14 wherein the computer is programmed to perform the transaction from inserted coins to the delivery of the good or service by operations including:
initiating the transaction upon insertion of a coin to the coin delivery system;
processing the inserted coins using the coin delivery system; and,
completing the transaction upon insertion of a minimum predetermined fee, thereby dispensing the good or service.

16. The system of claim 15 wherein the computer is further programmed to:
record the denomination of the coin inserted into the coin delivery system in said data storage means;
record the coin holding unit of the temporary holding stack device holding the inserted coin in said data storage means; and,
electronically signal the coin sorting device to sort the inserted coins using the data recorded in the data storage means.

17. The system of claim 12 wherein the coin transport further comprises:
a coin carriage having a coin input slot and adapted to carry a coin, said coin carriage having a coin output slot; and,
a slider shaft positionable in the coin transport and adapted to facilitate movement of the coin carriage within the coin transport.

18. A temporary holding stack device adapted for use in a coin-operated vending machine, the device comprising:
a coin input slot capable of facilitating the insertion of coins inserted by way of payment during a vending machine transaction into the temporary holding stack device;
an internal cavity adapted to temporarily hold the inserted coins during the transaction;
a plurality of coin holding units positionable within said internal cavity of the temporary holding stack device and adapted to hold the coins inserted during the transaction; and,
a coin output slot capable of facilitating the removal of the coins temporarily held by the temporary holding stack device,
wherein the coin holding units are spaced apart such that the held coins are not in contact with other coins inserted during the same transaction.

19. The device of claim 18 wherein the internal cavity further comprises:
sensors positionable in the internal cavity of the temporary holding stack device, said sensors capable of identifying and recording the type of coin inserted into the temporary holding stack device and the coin holding unit of the temporary holding stack device temporarily holding the coin.

20. A system for delivering coins during a vending machine transaction, said coins inserted by way of payment, and said vending machine designed to dispense a good or service, the coin delivery system comprising:
the temporary holding stack device of claim 18,
wherein the coin delivery system is capable of performing the user transaction separate from the sorting of inserted coins.
